(19) United States
(12) Patent Application Publication
(10) Pub. No.: US 2013/0228276 A1
(43) Pub. Date: Sep. 5, 2013

(54) METHOD FOR MANUFACTURING COVER PLATE AND METHOD FOR MANUFACTURING ENCAPSULATED LIGHT-EMITTING DIODE USING THE COVER PLATE

(71) Applicant: Kuo-Kuang Chang, Taichung City (TW)

(72) Inventor: Kuo-Kuang Chang, Taichung City (TW)

(21) Appl. No.: 13/884,879

(22) PCT Filed: Nov. 10, 2010
(86) PCT No.: PCT/CN10/78609

§ 371 Date: May 10, 2013

(51) Int. Cl. B29C 65/00

(52) U.S. Cl. CPC B29C 65/00
USPC 156/285; 264/496

(57) ABSTRACT

A method for manufacturing a cover plate and a method for manufacturing an encapsulated LED using the cover plate are disclosed. The cover plate is manufactured by the following steps: mixing uncured acryl and fluorescent powder, defoaming, inject-molding and curing. The cover plate can be used for manufacturing an encapsulated LED, which can avoid or minimize the fluorescent powder being heated or being eroded by moisture, and can keep stability of the fluorescent powder, thereby increasing service life of the encapsulated LED.

### BACKGROUND OF THE INVENTION

1. Field of the Invention

The present invention relates to an encapsulated LED, more particularly, to a method for manufacturing a cover plate and a method for manufacturing an encapsulated LED using the cover plate.

2. Description of the Prior Art

A conventional encapsulated LED is made by blending fluorescent powder in silica gel or epoxy resin, and the LED chip is encapsulated with silica gel or epoxy resin. Light emitted by the LED is able to excite the fluorescent powder so that visible light in various colors is generated.

However, the conventional encapsulated LED is not stable enough and is not durable. Specifically, the silica gel or the epoxy resin may be eroded due to moisture so that the fluorescent powder may be influenced by moisture to result in degeneration. Thus, the package of LED is not durable. Besides, the LED chip may generate heat when being used so that the temperature is getting relatively high, so the silica gel, the epoxy resin, or the fluorescent powder around the LED chip may degenerate. Thus, the durability of the encapsulated LED is decreased.

The present invention is, therefore, arisen to obviate or at least mitigate the above mentioned disadvantages.

### SUMMARY OF THE INVENTION

An object of the present invention is to provide an encapsulated LED having lasting service life and excellent stability and to provide a method for manufacturing the encapsulated LED.

To achieve the above and other objects, a method for manufacturing a cover plate includes steps of: material preparation: preparing acrylic glue and fluorescent powder, the acrylic glue referring to an uncured acrylic material; mixing: mixing the acrylic glue and the fluorescent powder according to a predetermined ratio to form an intermediate having viscosity of 1000-3000 CPS, the fluorescent powder being between 5-50 percent by weight; defoaming: disposing the intermediate in vacuum condition with assistance of a vacuum device so as to evacuate air inside the intermediate from the intermediate; inject-molding: injecting the defoamed intermediate into a mold and evacuating bubbles produced as the intermediate injected into the mold by the vacuum device; curing: irradiating the intermediate in the mold with ultra-violet of luminous exposure of 3000-3500 MM joule/mm² for 20-40 seconds so as to cure the intermediate to form the cover plate; and demolding: separating the cover plate and the mold from each other.

To achieve the above and other objects, a method for manufacturing an encapsulated LED includes the method for manufacturing the cover plate and further includes steps of: material preparation: preparing a base plate and a cover plate, the base plate having a first face and a second face, the cover plate having a third face and a fourth face, a flange being formed on one of the second face of the base plate and the third face of the cover plate, a recess being defined by the flange; circuit setting up: arranging at least one LED circuit on the second face of the base plat the LED circuit including at least one LED chip; and fixation: fixing the cover plate onto the base plate in vacuum condition so that the recess is closed to form a closed space, the LED circuit being located in the closed space.

Whereby, the cover plate can be used for manufacturing an encapsulated LED. The cover plate is used to cover the LED or the LED chip, which can avoid or minimize the fluorescent powder being heated or being eroded by moisture, and can keep stability of the fluorescent powder, thereby increasing service life of the encapsulated LED.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a partial cross-sectional view of an encapsulated LED manufactured by a method according to a preferred embodiment of the present invention;

FIG. 2 is a flow chart of a method for manufacturing a cover plate according to a preferred embodiment of the present invention; and

FIGS. 3-6 are drawings demonstrating a process of manufacturing an encapsulated LED according to a preferred embodiment of the present invention.

### DETAILED DESCRIPTION OF THE PREFERRED EMBODIMENTS

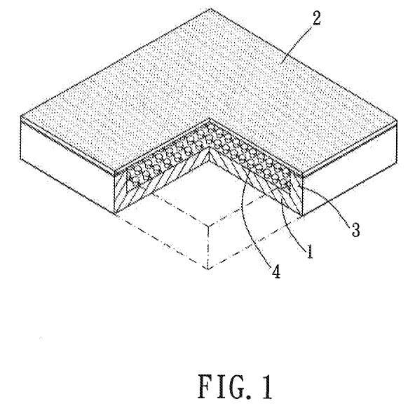

A method for manufacturing a cover plate is disclosed. The cover plate can be adapted to use in manufacturing an encapsulated LED such as one shown in FIG. 1.

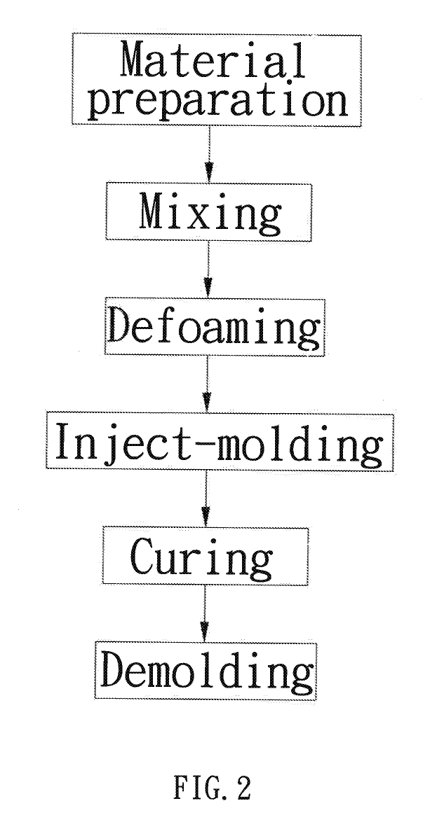

As shown in FIG. 2, a method for manufacturing a cover plate includes the following steps.

Material Preparation:

Acrylic glue and fluorescent powder are prepared, wherein the acrylic glue refers to uncured acrylic material, the aforementioned acrylic glue mixed with the fluorescent powder preferably includes methylmethacrylate, methylmethacrylate oligomer and photoinitiator and is irradiated with ultra-violet to be polymerized to form as solid acrylic, and the fluorescent powder refers to powdered fluorescent material.

Mixing:

The acrylic glue and the fluorescent powder are mixed according to a predetermined ratio to form an intermediate having viscosity of 1000-3000 CPS, and the fluorescent powder is preferably between 5-50 percent by weight. For obtaining white light generated by various LEDs, the fluorescent powder may includes merely yellow fluorescent powder, R.G.B (red, green, and blue) fluorescent powder, yellow and red fluorescent powder, red and green fluorescent powder, or orange and green fluorescent powder.

Defoaming:

The intermediate is disposed tin vacuum condition with assistance of a vacuum device so as to evacuate air inside the intermediate from the intermediate.

Inject-Molding:

The defoamed intermediate is injected into a mold, the inject-molding step is preferably carried out in vacuum condition so as to avoid unexpected amount of residual of air or bubbles between the intermediate and the mold. Certainly, it may be the best way for completely evacuating the bubbles produced as the intermediate injected into the mold by the vacuum device.

Curing:

The intermediate in the mold is irradiated with ultra-violet of luminous exposure of 3000-3500 MM joule/mm² for 20-40 seconds (preferably 3000-3500 MM joule/mm² for 30 seconds) so as to cure the intermediate to form the cover plate.

Demolding:

The cover plate and the mold are separated from each other.

Preferably, each step before the curing step is carried out in a photolithography room so as to avoid that the acrylic glue is unexpectedly irradiated and cured in advance by environmental ultra-violet.

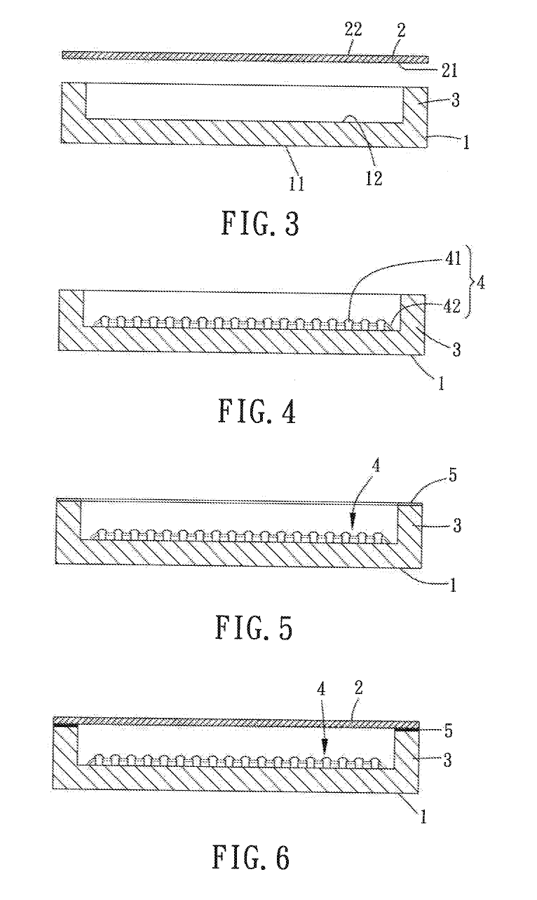

The cover plate manufactured through the above steps may be applied in a method for manufacturing an encapsulated LED. As shown FIGS. 3 to 6, the method for manufacturing an encapsulated LED includes the following steps.

Material Preparation:

A base plate 1 and a cover plate 2 are prepared. The base plate 1 has a first face 11 and a second face 12. The cover plate 2 has a third face 21 and a fourth face 22. A protruded flange 3 is formed on the second face 12 of the base plate 1, and a recess is defined by the flange 3. Specifically, the flange 3 can be integrally formed on the base plate 1 or be an individual element fixed on the base plate 1 by adhesive. In other possible embodiments, the flange 3 may be disposed or formed on the third face 21. The cover plate 2 is here a cover plate that manufactured by the aforementioned method for manufacturing a cover plate. More specifically, the cover plate 2 includes fluorescent powder distributed therein and is made primarily of acrylic so that the cover plate 2 is transparent and allows light passing therethrough. Preferably, the cover plate 2 is formed with bumpy patterns on the third face 21 or the fourth face 22 so as to reflect or refract light for various purposes.

Circuit Setting Up:

As shown in FIG. 4, at least one LED circuit 4 is fixedly disposed on the second face 12 of the base plate 1. The LED circuit 4 includes at least one LED chips 41 and cables 42 connected to the LED chips 41. Preferably, SMT (Surface Mount Technology) is applied for arrangement of the LED circuit 4.

Fixation:

The cover plate 2 is fixed disposed onto the base plate 1 in vacuum condition, and the recess is closed by the cover plate 2 and the base plate 1 to form a closed space. Specifically, the closed space is preferably vacuumed and the LED circuit 4 is located in the closed space. The cover plate 2 and the base plate 1 are fixed together by a photopolymer 5 therebetween. In other possible embodiments of the present invention, the cover plate 2 may be made of meltable material, and the cover plate 2 is heated by high frequency heating device to fix the cover plate 2 and the base plate 1 together.

By the previous steps, the package of LED as shown in FIG. 1 can be manufactured. Specifically, the LED chip 41 is separated from the cover plate 2 and the closed space is vacuumed so that heat generated by the LED chip 41 is hardly to be transmitted to the cover plate 2. Thus, the fluorescent material in the cover plate 2 is prevented from degeneration due to heat. In addition, the fluorescent powder in the cover plate 2 is embedded in acrylic material of the cover plate 2, so the fluorescent material is prevented from being directly exposed outside so that the fluorescent material is prevented from degeneration due to moisture or the like.

Besides, since the closed space between the cover plate 2 and the base plate 1 is vacuumed, light emitted by the LED chip 41 is prevented from contacting air to result in decaying. Thus, illuminant efficiency is promoted. On the other hand, the cover plate 2 is optionally formed with bumpy patterns for better light-focusing and illuminating effects. Preferably, additional protection layer may be arranged on the fourth face of the cover plate 2 so as to prevent the cover plate 2 from abrasion or erosion.

Given the above, the method of the present invention can be easily carried out to manufacture a cover plate, and the cover plate can be used for manufacturing an encapsulated LED, in which the encapsulated LED can have improved stability and service life.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method for manufacturing a cover plate, including steps of:
material preparation: preparing acrylic glue and fluorescent powder, the acrylic glue referring to an uncured acrylic material;
mixing: mixing the acrylic glue and the fluorescent powder according to a predetermined ratio to form an intermediate having viscosity of 1000-3000 CPS, the fluorescent powder being between 5-50 percent by weight;
defoaming: disposing the intermediate in vacuum condition with assistance of a vacuum device so as to evacuate air inside the intermediate from the intermediate;
inject-molding: injecting the defoamed intermediate into a mold and evacuating bubbles produced as the intermediate injected into the mold by the vacuum device;
curing: irradiating the intermediate in the mold with ultra-violet of luminous exposure of 3000-3500 MM joule/mm² for 20-40 seconds so as to cure the intermediate to form the cover plate; and
demolding: separating the cover plate and the mold from each other.

2. The method for manufacturing a cover plate of claim 1, wherein in the curing step, the intermediate is irradiated with ultra-violet of luminous exposure of 3000-3500 MM joule/mm for 30 seconds.

3. The method for manufacturing a cover plate of claim 1, wherein the inject-molding step is carried out in vacuum condition.

4. The method for manufacturing a cover plate of claim 1, wherein each step before the curing step is carried out in a photolithography room.

5. The method for manufacturing a cover plate of claim 1, wherein the acrylic glue includes methylmethacrylate, methylmethacrylate oligomer and photoinitiator.

6. A method for manufacturing an encapsulated LED, including the method for manufacturing a cover plate of claim 1, the method for manufacturing an encapsulated LED including steps of:
material preparation: preparing a base plate and a cover plate, the base plate having a first face and a second face, the cover plate having a third face and a fourth face, a flange being formed on one of the second face of the base plate and the third face of the cover plate, a recess being defined by the flange;
circuit setting up: arranging at least one LED circuit on the second face of the base plate, the LED circuit including at least one LED chip; and
fixation: fixing the cover plate onto the base plate in vacuum condition so that the recess is closed to form a closed space, the LED circuit being located in the closed space.

7. The method for manufacturing an encapsulated LED of claim 6, wherein in the fixation step, the cover plate and the base plate are fixedly connected to each other using photopolymer.

8. The method for manufacturing an encapsulated LED of claim 6, wherein the third face of the cover plate is formed with bumpy patterns.

9. The method for manufacturing an encapsulated LED of claim 6, wherein the fourth face of the cover plate is formed with bumpy patterns.
